(19) United States
(12) Patent Application Publication
(10) Pub. No.: US 2010/0049562 A1
(43) Pub. Date: Feb. 25, 2010

(54) SYSTEM AND METHOD FOR REPORTING CONTINUING EDUCATION

(76) Inventors: David White, Round Rock, TX (US); Sherry Reisman, Round Rock, TX (US)

Correspondence Address: HAYNES AND BOONE, LLP;IP Section, 2323 Victory Avenue, Suite 700, Dallas, TX, 75219, US

(21) Appl. No.: 12/196,915

(22) Filed: Aug. 22, 2008

(51) Int. Cl. G06Q 10/00; G06F 17/30; G06Q 50/00; G06K 5/00; G06F 7/06

(52) U.S. Cl. 705/7; 707/102; 707/3; 235/380; 707/E17.044; 707/E17.014

(57) ABSTRACT

A system, method, and software package configured to monitor and report continuing education attendance. The system may include a plurality of kiosks positioned at a continuing education location, wherein the kiosks are configured to monitor conference attendees attendance at particular educational seminars. The kiosks may then generate a continuing education certificate for the user to present to the governing body, or alternatively, the kiosks may independently transmit the continuing education certificate to the governing body on behalf of the conference attendee.

### BACKGROUND

1. Field of the Invention

Embodiments of the invention may generally provide a system, method, or software package configured to electronically track and report continuing education requirements.

2. Description of Related Art

Various professions require practitioners within the profession to maintain a predetermined level of annual continuing education in order to maintain a certification or license from a governing body for the profession. The medical field, legal field, and various skilled trades use continuing education to ensure that its practitioners stay current with new practices, procedures, requirements, or other developments within the profession. Continuing education is generally offered in the form of classes, seminars, or conferences where a large number of participants attend. The continuing education class or conference may be sponsored by various organizations, but generally the class or conference must be approved by the profession's governing body to qualify for continuing education credit for the particular profession. When a continuing education class or conference is approved by a governing body, the class or conference is generally assigned a continuing education number by the governing body, which may be used by both the governing body and practitioners to identify a particular continuing education class or conference. Thus, when a practitioner attends a continuing education class or conference, the practitioner is generally provided with the continuing education number, and the practitioner, after attending the class or conference, may fill out and submit formal documents to the governing body to verify that the practitioner has in fact attended the class or conference. In response to the practitioners' submission, the governing body may grant continuing education credit to the practitioner.

However, the process of each participant manually submitting documents to verify their continuing education class or conference attendance presents several challenges for both attendees and governing organizations. For example, standardization of the continuing education certification documents received by the governing body is difficult to achieve, as various organizations generally sponsor various types of continuing education classes or seminars, thus resulting in the receipt of variously formatted documents claiming continuing education credit. Additionally, participants often have busy careers, and as such, participants often forget to submit the continuing education certification documents, thus resulting in their license or certification being suspended until continuing education requirements are met.

Therefore, there is a need for an improved system, method, or software package configured to track continuing education attendance and to simplify the process of submitting continuing education documentation to the appropriate governing body for credit.

### SUMMARY OF THE DISCLOSURE

Embodiments of the invention described herein may generally provide an improved system, method, or software package configured to track continuing education attendance and to simplify the process of submitting continuing education documentation to the appropriate governing body for continuing education credit. This system, method, or software package may be configured to electronically track attendees at a continuing education seminar or conference, and then to either produce a standardized continuing education certificate that may be submitted by the attendee to the respective governing body, or alternately, to generate the continuing education certificate and electronically submit the certificate to the governing body on behalf of the participant.

Embodiments of the invention may generally provide a method for tracking, recording, and reporting continuing education credit for a plurality of continuing education conference attendees. The method may include assigning a unique identification number to each of a plurality of conference attendees, assigning a unique workshop identification number to each of a plurality of workshops offered to the plurality of attendees at the conference, associating the unique workshop identification number with each of the plurality of conference attendees that attend the workshop, generating a summary of all workshops attended by each of the plurality of conference attendees, and generating a continuing education certificate representing the summary of the workshops attended by each of the plurality of conference attendees.

Embodiments of the invention may further provide a computer program embodied on a computer readable medium, that when executed by a processor, is configured to control a method for tracking and reporting continuing education credit for a plurality of continuing education conference attendees. The method controlled by the computer program may include assigning a unique identification number to each of a plurality of conference attendees and a unique workshop identification number to each of a plurality of workshops offered at a continuing education conference, reading the unique identification number for each attendee at a particular workshop and associating the unique workshop identification number with each workshop attendee's unique identification number in a conference database, and generating continuing education certificate representing each workshop attended by each conference attendee.

Embodiments of the invention may further provide a system for tracking and reporting continuing education credits for a plurality of continuing education conference attendees. The system may include a plurality of kiosks in communication with each other, an input module and an output module, a processor in communication with the input module and the output module, a memory configured to contain a computer program for controlling the tracking and reporting process, and at least one database in communication with the processor, the database containing a unique attendee identification number for each conference attendee and a unique workshop identification number for each workshop offered at the conference. The plurality of kiosks may be configured to receive inputs representative of conference attendees attending specific workshops and to generate a corresponding continuing education certificate representative thereof.

### BRIEF DESCRIPTION OF THE DRAWINGS

The present disclosure is best understood from the following detailed description when read in conjunction with the accompanying Figures. It is to be noted, however, that the accompanying Figures illustrate only exemplary embodiments of the invention and are therefore not to be considered limiting of its scope, for the invention may admit to other equally effective embodiments.

FIG. 1 illustrates an exemplary education tracking system of the invention; and

FIG. 2 illustrates an exemplary method of the invention;

### DETAILED DESCRIPTION

It is to be understood that the following disclosure describes several exemplary embodiments of the invention, along with exemplary methods for implementing or practicing the invention. Therefore, the following disclosure describes exemplary components, arrangements, and configurations that are intended to simplify the present disclosure, and these exemplary embodiments are merely examples of various possible configurations and implementations of the invention and are not intended to be limiting upon the scope of the invention in any way. Further, the present disclosure may repeat reference numerals and/or letters in the various exemplary embodiments and across multiple Figures. Applicants note that this repetition is for the purpose of simplicity and clarity and does not in itself dictate a relationship between the various exemplary embodiments and/or configurations discussed herein. Additionally, where the following disclosure describes structural relationships between the elements of a particular embodiment, the particular structural relationship described is not intended to be limiting upon the scope of the invention, as the inventors contemplate that various components may be interstitially positioned without departing from the true scope of the invention. Similarly, where method steps are described, unless expressly stated herein, the invention is not intended to be limited to any particular sequence of the method steps described. Further, the invention is not intended to be limited only to the method steps described, as various additional steps may be implemented in addition to the described method steps without departing from the true scope of the invention.

Additionally, in various embodiments, the invention may provide advantages over the prior art; however, although embodiments of the invention may achieve advantages over other possible solutions and the prior art, whether a particular advantage is achieved by a given embodiment is not intended in any way to limit the scope of the invention. Thus, the following aspects, features, embodiments, and advantages are intended to be merely illustrative of the invention and are not considered elements or limitations of the appended claims; except where explicitly recited in a claim. Similarly, references to “the invention” herein should neither be construed as a generalization of any inventive subject matter disclosed herein nor considered an element or limitation of the appended claims, except where explicitly recited in a claim. Additionally, where lists of elements or steps are recited herein, the invention is not intended to be limited to the inclusion of each of the elements from the list. Rather, the inventors intend that the invention may include various combinations of elements from the element list, and as such, the invention is not intended to be limited to any particular combination or list of elements recited herein, other than that which is expressly recited in the claims.

Further, at least one embodiment of the invention may be implemented as a program product for use with a computer system or processor. The program product may define functions of the exemplary embodiments (which may include methods) described herein and can be contained on a variety of computer readable media. Illustrative computer readable media include, without limitation, (i) information permanently stored on non-writable storage media (e.g., read-only memory devices within a computer such as CD-ROM disks readable by a CD-ROM drive); (ii) alterable information stored on writable storage media (e.g., computer disks for use with a disk drive or hard-disk drive, writable CD-ROM disks and DVD disks, zip disks, portable memory devices, and any other device configured to store digital data); and (iii) information conveyed across communications media, (e.g., a computer, telephone, wired network, or wireless network). These embodiments may include information shared over the Internet or other computer networks. Such computer readable media, when carrying computer-readable instructions that perform methods of the invention, may represent embodiments of the present invention.

Further still, in general, software routines or modules that implement embodiments of the invention may be part of an operating system or part of a specific application, component, program, module, object, or sequence of instructions, such as an executable script. Such software routines typically include a plurality of instructions capable of being performed using a computer system or other type or processor configured to execute instructions from a computer readable medium. Also, programs typically include or interface with variables, data structures, etc., that reside in a memory or on storage devices as part of their operation. In addition, various programs described herein may be identified based upon the application for which they are implemented. Those skilled in the art will readily recognize, however, that any particular nomenclature or specific application that follows facilitates a description of the invention and does not limit the invention for use solely with a specific application or nomenclature. Furthermore, the functionality of programs described herein may use a combination of discrete modules or components interacting with one another. Those skilled in the art will recognize, however, that different embodiments may combine or merge such components and modules in a variety of ways.

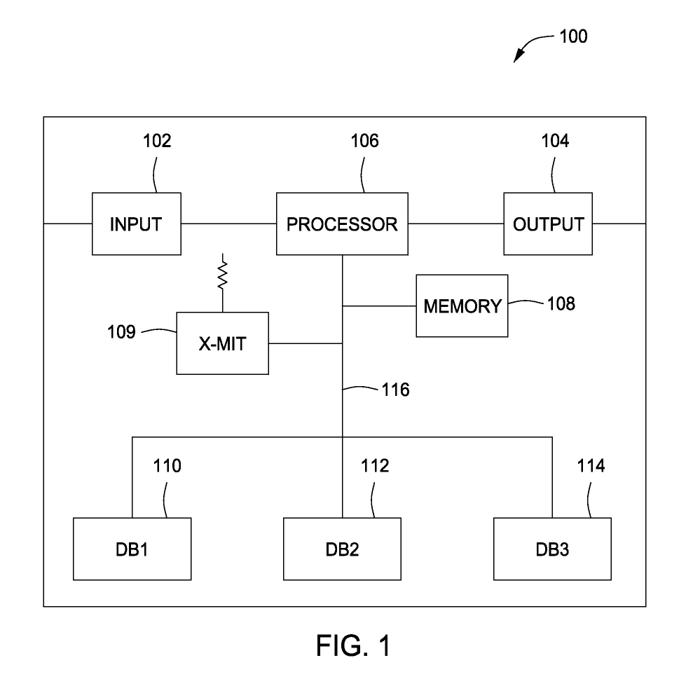

FIG. 1 illustrates an exemplary education tracking system of the invention. The exemplary education tracking system 100 generally includes an input module 102 and an output module 104 cooperatively configured to receive inputs from external devices, process the inputs therein, and send outputs to external devices. The input module 102 may, for example, be a data port, such as a standard CAT 5—type network connector for a computer processor configured to receive data inputs from a plurality of external devices. Similarly, the output module 102 may also be a standard CAT 5—type network connector configured to transmit data to a plurality of external devices either directly or via a supporting network. Other types, sizes, or configurations of communication devices or modules, including wireless communication and networking devices, may be used without departing from the scope of the invention.

A processing module or unit 106 may be positioned between the input module 102 and the output module 104, and be in communication therewith. The processing module 106 is generally configured to receive inputs from the input module 102, to process the inputs in accordance with a predetermined algorithm or software process, and then generate outputs that may be transmitted to external devices via the output module 104. The exemplary system 100 may also include a data bus 116, as is generally known in the art, configured to interconnect the various components of system 100. For example, input module 102, output module 104, and processor 106 may all be in communication with the data bus 116, and therefore, each of these components may be configured for communication there between. Additionally, a memory 108, such as a hard disk drive or other memory configured to contain data or software instructions thereon, may also be in communication with the data bus 116. The memory 108 may generally be configured to support the processor 106, i.e., memory 108 may generally contain software instructions to be executed by processor 106 to control the methods and processes to be executed by the exemplary education tracking system 100.

System 100 may further include a transmission module 109 configured to communicate with various external devices via radio frequency, optical, or other non-wire-type connections. For example, in embodiments of the invention where there are a plurality of educational tracking systems 100 at a particular location, the transmission modules 109 of the respective tracking systems 100 may be used to communicate data, command instructions, etc. between the respective systems.

The exemplary education tracking system 100 may further include a plurality of databases 110, 112, 114. These databases 110, 112, 114 may be positioned at the same location as system 100, i.e., within the same framework a system 100, or alternatively, one or more of the databases 110, 112, 114 may be positioned at remote locations. Remote locations may include positioning the database within another education tracking system 100, within another data network, or in a stand-alone system. In embodiments of the invention where one or more of the databases 110, 112, 114 are positioned remotely, then the education tracking system 100 may be configured to communicate with the remotely positioned database via an appropriate communication link or supporting network. For example, the educational tracking system 100 may be in communication with a computer network, which may be in communication with one or more remotely positioned databases. In another embodiment of the invention, the educational tracking system 100 may be in communication with a remotely positioned database via a telephone line-type connection, a cellular connection, an optical connection, a radio frequency connection, a satellite communication system, or any other type of connection generally used to communicate data between two remotely positioned devices.

In one embodiment of the invention, a first database 110 is positioned locally and in communication with the educational tracking system 100, while a second database 112 and a third database 114 are positioned remotely and in communication with the educational tracking system 100 of the invention. In at least one embodiment of the invention, a plurality of kiosks each containing the educational tracking system 100 may be positioned around the educational conference location. Each of the individual kiosks may then be in communication with a main control station, which may either be located on site at the educational conference, or alternatively, the main control station may be located remotely and be in communication with each of the kiosks at the conference via a communication or computer network system. In embodiments of the invention where a main station is used, the main station may be in communication with a plurality of kiosks at a plurality of different conference locations, and as such, the main station may be used to monitor and control kiosks at a plurality of conference locations.

Regardless of the position of the individual database 110, 112, 114, the inventors contemplate that the respective databases may include any type of data storage configuration or device. For example, each of the respective databases may simply be a table of data contained in a digital storage medium, such as a computer memory, hard drive, or other commonly used digital storage device. Additionally, although the present exemplary embodiment illustrates three databases 110, 112, 114, embodiments of the invention are not limited to any particular number of databases. Rather, the inventors contemplate that the illustrated databases may be combined into fewer databases, including a single database, and alternatively, additional databases may be added to the educational tracking system 100, without departing from the scope of the invention.

In one exemplary embodiment of the invention, system 100 may be configured to track the attendance of persons attending an educational conference. In this embodiment, the first database 110 may include information such as conference attendee data. The conference attendee data may include a unique identification number assigned to each individual attendee of the conference, first and last name of the attendee, the educational background of the attendee, the type of degree held by the attendee, and/or any other identification or verification information that may be needed to support the conference or education verification process.

In at least one embodiment of the invention, the conference attendee data may be configured to allow the educational tracking system 100 to have enough information to certify that a particular attendee of the conference has met an educational requirement set by a third-party organization, such as a legal bar association or a medical certifying board or association. For example, in the situation where the educational conference is directed to those in the legal profession, then the attendee data may include information such as the attendees state bar registration number, the attendees court registration numbers, or any other information that may be required by the attendees state bar to record and receive certified legal education credit for the attendee completing the educational conference. Similarly, if the attendee is in the medical profession, such as a psychologist, for example, then the attendee data may be configured to support submission of the successful completion of the course or seminar by the attendee to the attendees particular medical board or licensing certification body.

Generally speaking, as noted above, each individual attendee is also assigned a unique identification number that is stored in the first database 110. The unique identification number is generally used only to represent a particular attendee, and may be assigned by the owner or operator of the educational tracking system 100. Thus, each attendee of an educational seminar or conference may be assigned a unique numerical, textual, and/or alphanumeric identification that may be stored in the first database 110 and used by the educational tracking system 100 to identify the particular attendee in every conference activity. This unique identification may be selected by the operator of the educational tracking system 100, or in another embodiment, the unique identifier may be selected by the attendee. For example, the unique identifier may be the attendee social security number, driver's license number, bar association number, or other identifier that is unique to the particular individual or attendee. In an exemplary embodiment of the invention, the unique identifier may be selected by the conference attendee.

In one embodiment of the invention, the provider or organizer of the conference or educational program may receive or assign each conference attendee's unique identification number during the registration process. As such, since the registration process for conferences is generally in advance of the conference itself, the attendee information for the first database 110 may generally be generated and stored in the first database 110 prior to the conference starting. However, the inventors recognize that preloading of the first database 110, although efficient and useful, is not practical for a obtaining 100% of the attendee information, as there are inherently late registrations and late arrivals to the conference that will require additions to the conference attendee information stored in the first database 110. As such, the inventors contemplate that a portion of the information to be stored in first database 110 may be preloaded via pre-registration information, while also allowing for additional attendee information to be added to the first database 110 as necessary in order to accommodate for late registrations and/or modifications to previously entered attendee data.

The second database 112, which may also be a table or any other data structure configured to store information in a digital media, may include information on a particular workshop or seminar attendees. To help distinguish the workshop attendee information from the conference attendee data previously discussed as being saved in the first database 110, the inventors note that often times educational conferences include a plurality of workshops or seminars that may be conducted simultaneously. Thus, the workshop attendee information contained in the second database 112 may generally be directed to the specific or more narrow workshops or seminars that conference attendees participate in, where the conference attendee data generally represents all of the attendees of the overall conference and does not relate any particular attendee to any particular seminar or workshop that may be attended. More particularly, the workshop attendee information may generally include a unique workshop number or identifier that corresponds to the particular workshop or topic presented in the workshop. Similarly, the second database 112 may also include the unique identification number of each attendee of the particular workshop or seminar represented by the unique workshop number. Thus, the combination of the unique workshop number and the unique identification number of each attendee that participated in a unique workshop allows the educational tracking system 100 to determine which of the conference attendees attended each individual unique workshop by simply tabulating the number of conference attendees that are in the second database 112 having a particular unique workshop number associated with their particular attendee identifier.

The third database 114, which may also be a table or any other data structure configured to store information in a digital media, may include information related to a particular workshop or seminar at the overall educational conference. For example, the third database 114 may include the unique workshop number, as described with regard to the second database 112, along with the name and or title of the workshop, the date of the workshop, the start and or end times of the workshop, the educational credit hours for the particular field or discipline of the attendee, the persons presenting the educational material at the workshop, and/or any other information related to the particular seminar or workshop. The third database 114 may be positioned in the educational tracking system 100, or may be positioned remotely, depending upon the particular configuration of the educational tracking system 100. Thus, the information contained in the third database 114 may generally be a link for the information contained in the first database 110 and the second database 112.

The three databases 110, 112, 114 cooperatively operate to receive and store the information related to a particular educational conference attendee, and more particularly, the information stored in the database may be used to obtain a completion certificate for each of the attendees at the conference from the attendees practice governing organization/body or the party operating the educational tracking system. For example, if an educational seminar is directed to psychologists, then the information collected from both the seminar attended and the educational tracking system 100 may be calculated or configured to satisfy the continuing education recording requirements for the American Psychological Association. Thus, the education tracking system 100 of the invention may be configured to both track the attendance of a psychologist at a particular continuing education seminar, and to submit the appropriate documents verifying the psychologist's attendance at the continuing education seminar to the psychologist's licensing governing body. As such, the education tracking system 100 of the invention may be configured to minimize and/or eliminate the steps necessary for a practitioner to track attendance at a particular educational conference, and thereafter submit verifying documents to the appropriate governing body to obtain credit for the attendance at the seminar.

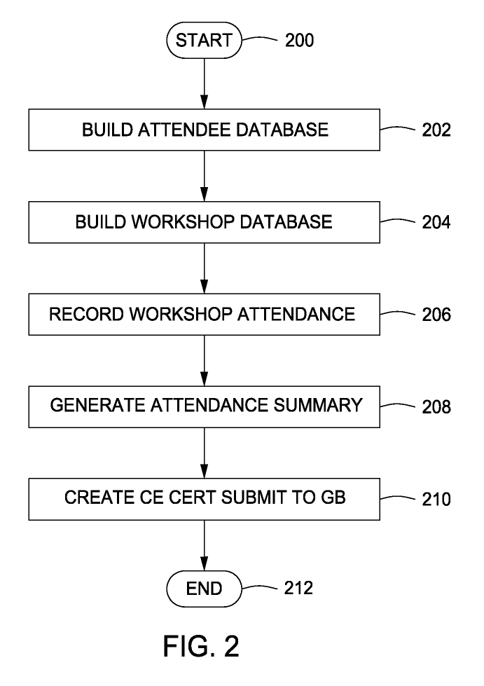

FIG. 2 illustrates an exemplary method of the invention. However, Applicants note that the exemplary method illustrated in FIG. 2 is not intended to limit the sequence of events encompassed by the present invention, as the invention may utilize any number of the listed exemplary steps in any order, without limitation. The exemplary method illustrated in FIG. 2 begins at step 200, and continues to step 202, were the attendee database is built or generated. The attendee database, which may include the conference attendee data referenced with regard to the first database 110 in FIG. 1, may include information configured to identify each potential attendee of an educational conference. In one exemplary embodiment of the invention, the conference attendee data may be entered into a database, such as first database 110, from the conference registration information received from attendees reserving a spot in the conference. The conference attendee information may be electronically received by a conference organizer, and then electronically transmitted to the exemplary educational tracking system 100 of the invention, where the conference attendee information may be sorted and organized into one or more database(s) in accordance with step 202. Additionally, the process of storing the conference attendee data into the first database 110 may also include assignment of a unique conference attendee identification number to each individual conference attendee. This unique conference attendee identification number may be a randomly generated number, a predetermined number, and assigned number, or any other number that may be used to uniquely identify a conference attendee from each of the other attendees at the conference. Additionally, the attendee identification number may also include text, symbols, and combinations thereof.

Once the identification number is assigned, the method may continue to step 204, were the workshop database may be generated. The workshop database may generally be populated with information relative to the individual workshops or seminars provided at the educational conference. This information may include, for example, each individual workshop's name, title, date, time, duration, the presenter, and/or any other information specific to the individual workshop that may be desired for the process of recording continuing education to a governing body. An additional piece of information that may be included in the workshop data may be a unique workshop identification number, text string, sequence of symbols, or any combination thereof that may be assigned by the organizer of the conference or the party operating the educational tracking system 100 of the invention. The unique workshop identification number generally represents a particular workshop, and may be used to distinguish one particular workshop from another particular workshop in recording continuing education requirements to a governing body. In one exemplary embodiment of the invention, the workshop data may be stored in a third database, such as the third database 114 illustrated in FIG. 1 with respect to the exemplary educational tracking system 100.

At step 206, the exemplary educational tracking system 100 of the invention may receive or record information representative of workshop attendance at the above-mentioned educational conference. More particularly, at step 206 the educational tracking system 100 may receive inputs corresponding to the above-mentioned unique attendee identification number and an associated unique workshop identification number. These two identification numbers, when associated, represent that a particular attendee attended a particular workshop at the conference. As such, the exemplary education tracking system 100 processes the received data and determines that the attendee associated with the unique attendee identification number attended the particular workshop associated with the unique workshop identification number.

In at least one exemplary embodiment of the invention, the process of the exemplary educational tracking system 100 receiving or recording the unique workshop identification number and the corresponding unique attendee identification number may be conducted electronically. For example, attendees of a particular workshop may scan a bar code as they enter and/or exit the particular workshop. The barcode may include encoded information that represents the attendee's unique identification number, and the location of the scanner proximate the workshop area may be used to represent associate the unique workshop identification number, such that the combination of the attendee's identification number being scanned by the barcode scanner adjacent to a particular workshop may be used to determine that the particular attendee was in attendance at the particular workshop.

In yet another embodiment of the invention, conference attendees may be provided with a plurality of removable stickers having their unique attendee identification number thereon in this embodiment, when an attendee attends a particular workshop, the attendee may remove a sticker from the sheet and place the sticker ON an attendance list designated for the particular workshop they are attending. This attendance list may then be manually entered into the educational tracking system 100, or alternatively, the attendance list may be electronically scanned or otherwise electronically entered into the educational tracking system 100.

In other embodiments of the invention, the process of recording individual attendees at a particular workshop may be accomplished by electromagnetic identification techniques, optical scanning techniques, stickers, barcodes, optical character recognition techniques, and any other technique or process known to be able to identify a particular person entering and/or leaving a particular location, such as an educational seminar. Regardless of the process or method used to obtain the list of attendees associated with a particular workshop, once the data has been obtained, the data may be stored in a second database, such as second database 112 illustrated in the exemplary educational tracking system 100 of FIG. 1. The information stored in second database 112 may be stored in a table, data file, document, or any other electronic data storage format.

At step 208, the exemplary method generates an attendance summary for a particular conference attendee. For example, in one embodiment of the invention, once a conference attendee has attended all of these seminars or workshops desired at a particular conference, the attendees may access the education tracking system 100 of the invention to obtain a summary of each workshop attended at the conference. The exemplary education tracking system 100 may be configured as one or a plurality of kiosks stationed at various locations at the conference. The attendee may interact with an individual kiosk via, for example, a keyboard, mouse, interactive touch screen-type display, or any other device or apparatus configured to interact with a computer type system. The attendee may be prompted by system 100 to enter an identification number, such as the attendee's unique identification number, and thereafter, system 100 may provide the attendee with a printed summary of the workshops or seminars attended at the particular educational conference, as illustrated at step 210 in FIG. 2.

In at least one embodiment of the invention, the printed summary provided by system 100 may be configured to satisfy a particular governing bodies submission requirements for continuing education. For example, in an embodiment of the invention where the seminar or conference is a legal seminar for attorneys, the printed summary may be configured to satisfy the attendees respective state bar associations continuing legal education submission requirements. As such, system 100 may be configured to provide seminar attendees with a printed document that may be submitted to the attendees respective governing body for continuing education approval, thus eliminating the confusion and recordkeeping requirements associated with individual attendees submitting differing formatted requests for continuing education to their respective governing bodies.

In another exemplary embodiment of the invention, system 100 may be configured to provide a summary of the continuing education classes attended by a particular attendee, while also independently submitting the summary to the attendee's governing body. More particularly, system 100 may be configured to generate continuing education certifications for submission to various attendee's governing bodies, thus eliminating the need for the attendee to manually submit documentation to the governing body subsequent to attending the educational seminar. System 100 may be configured to submit continuing education documents to the respective governing bodies through, for example, e-mail transmissions, fax transmissions, or other electronic communications media suitable for transmitting a document and or continuing education data to a continuing education governing body. Once the continuing education certificate has been either printed for the attendee or transmitted to the governing body, the exemplary method of the invention ends at step 212.

In another exemplary embodiment of the invention, each attendee at a conference may be given an identification card, where the identification card contains the attendee's unique identification number. The unique identification number may be contained on the identification card in the form of a printed number, a barcode, or in at least one embodiment of the invention, the unique identification number may be encoded into the identification card in a manner that can be read by radio frequency or other types of scanning equipment. Therefore, in the present examplary embodiment, once a conference participant is given an identification card, the various databases containing the unique identification number for the attendee, the workshop, and the individual seminars, are already set up, and therefore, when the attendee chooses a particular workshop, the attendee may simply use the identification card to electronically indicate attendance at a particular workshop. For example, if an attendee at a conference were given the opportunity to attend one of four workshops, and that attendee chose workshop number one, then when the attendee entered into workshop number one, the attendee's identification card could be scanned, read, or otherwise viewed or sensed to determine the attendee's unique identification number. The determination of the identification number indicates the particular attendee's presence at the number one seminar. The attendees unique identification number, along with the workshop's unique identification number, may be collected by the educational tracking system 100 of the invention for processing, correlating, or storage. The processing may include generating a report after a predetermined time period, wherein the report indicates each seminar or workshop that each individual participants attended. This report may be presented to the user as a summary of attendance at a particular conference, and additionally, the report may be used to generate a continuing education certificate that may be either printed for the participants to submit to a governing body, or alternatively, the educational tracking system 100 may electronically or otherwise transmit the continuing education certificate for a particular participant to the governing body, thus eliminating the need for individual participants to personally handle (or likely forget to do so) the certificate submission to the governing body.

In another exemplary embodiment of the invention, various kiosks containing the educational tracking system 100 may be positioned at multiple locations around a conference location. In this embodiment of the invention, users may interact with the kiosks to select individual workshops or seminars that the attendee either plans to attend or has already attended at the conference. The process of the attendee indicating to the educational tracking system 100 which seminars or workshops the attendee has either already attended or plans to attend may include the attendee manually entering his/her attendee unique identification number and the unique workshop or seminar identification number for each workshop or seminar the attendee plans to or has already attended. Alternatively, the attendee may use the above noted identification card, stickers, or any other method known to be available for identifying a particular person or a particular class or seminar. Additionally, as noted above, the system 100 may also be configured to automatically track the attendee's movement at the conference to automatically determine what classes/seminars the attendee attended.

Regardless of the method used to obtain the data in the education tracking system 100 of the invention, once the data is obtained, the education tracking system 100 generally processes the data to generate continuing education and/or attendance records that may be used for continuing education certificates, as required by the governing body for a particular profession. The continuing education certificate may be generated by the educational tracking system 100 and printed for the user directly from one of the kiosks. The user may then submit the continuing education certificate to the governing body via mail, fax, or other known means for transmitting certificates to governing bodies. In one embodiment of the invention, the individual kiosks may be equipped with the capability to scan or fax a copy of the certificate directly to the governing body. This allows the user to print the certificate, sign the certificate (required in some jurisdictions), and then immediately send the certificate to the governing body at the kiosk. In another embodiment of the invention, the kiosk may scan or fax the signed certificate into memory, which allows for a subsequent bulk send of all collected certificates to the governing body and avoids possible fax or e-mail congestion that may accompany each individual user trying to send their certificate from a kiosk directly to the governing body.

In another embodiment of the invention, the user may select an option on the kiosk for the educational tracking system 100 of the invention to transmit the respective certificate to the governing organization on behalf of the attendee. In this embodiment, the educational tracking system 100 may transmit individual certificates, or a compilation of certificates, to the governing body for individuals who have attended continuing education classes or seminars at a particular conference. The transmission of the certificates to the governing body by the educational tracking system 100 may be accomplished via electronic file, fax, paper file, or other electronic data file of a proprietary format that may be set by the governing body. Regardless of the method used to transmit the certificate to the governing body, embodiments of the invention are configured to both track attendance at a continuing education conference, and then send a certificate verifying a participant's attendance at specific workshops to a governing body for the attendees profession.

Embodiments of the invention may generally provide a method for tracking, recording, and reporting continuing education credit for a plurality of continuing education conference attendees. The method may include assigning a unique identification number to each of a plurality of conference attendees, assigning a unique workshop identification number to each of a plurality of workshops offered to the plurality of attendees at the conference, associating the unique workshop identification number with each of the plurality of conference attendees that attend the workshop, generating a summary of all workshops attended by each of the plurality of conference attendees, and generating a continuing education certificate representing the summary of the workshops attended by each of the plurality of conference attendees.

Embodiments of the invention may further provide a computer program embodied on a computer readable medium, that when executed by a processor, is configured to control a method for tracking and reporting continuing education credit for a plurality of continuing education conference attendees. The method of the computer program may include assigning a unique identification number to each of a plurality of conference attendees and a unique workshop identification number to each of a plurality of workshops offered at a continuing education conference, reading the unique identification number for each attendee at a particular workshop and associating the unique workshop identification number with each workshop attendee's unique identification number in a conference database, and generating continuing education certificate representing each workshop attended by each conference attendee.

Embodiments of the invention may further provide a system for tracking and reporting continuing education credits for a plurality of continuing education conference attendees. The system may include a plurality of kiosks in communication with each other, an input module and an output module, a processor in communication with the input module and the output module, a memory configured to contain a computer program for controlling the tracking and reporting process, and at least on database in communication with the processor, the database containing a unique attendee identification number for each conference attendee and a unique workshop identification number for each workshop offered at the conference. The plurality of kiosks may be configured to receive inputs representative of conference attendees attending specific workshops and to generate a corresponding continuing education certificate representative thereof.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions and alterations herein without departing from the spirit and scope of the present disclosure.

What is claimed is:

1. A method for tracking, recording, and reporting continuing education credits for a plurality of continuing education conference attendees, comprising:
assigning a unique identification number to each of a plurality of conference attendees;
assigning a unique workshop identification number to each of a plurality of workshops offered to the plurality of attendees at the conference;
associating the unique workshop identification number for a particular workshop with each of the plurality of conference attendees that attend the particular workshop;
generating a summary of all workshops attended by each of the plurality of conference attendees; and
generating a continuing education certificate representing the summary of the workshops attended by each of the plurality of conference attendees.

2. The method of claim 1, further comprising populating at least one database with the unique identification number and the unique workshop identification number.

3. The method of claim 2, wherein populating the at least one database comprises conducting an attendee registration process for the conference.

4. The method of claim 3, wherein associating comprises determining when a particular conference attendee is present in a particular workshop by reading the particular conference attendee's unique identification number and adding the unique identification number associated with the workshop identification number to the populated database.

5. The method of claim 4, wherein generating the summary comprises generating a list of workshops attended by a particular conference attendee by determining which workshop identification numbers are associated with the particular attendees unique identification number in the populated database.

6. The method of claim 5, wherein generating a continuing education certificate comprises printing a continuing education certificate at a kiosk positioned proximate the conference.

7. The method of claim 5, wherein generating a continuing education certificate further comprises automatically transmitting a governing body compliant continuing education certificate representative of the particular conference attendee's attendance at continuing education workshops at the conference to a governing body.

8. The method of claim 7, wherein a plurality of kiosks are positioned at a conference location, the plurality of kiosks being in communication with each other, and further, each of the plurality of kiosks being in communication with a common database containing the attendee identification numbers and the workshop identification numbers.

9. The method of claim 4, wherein determining when a particular conference attendee is present in a particular workshop comprises scanning, optically or through radio frequency, an attendee identification card at an entrance to the workshop.

10. A computer program embodied on a computer readable medium, that when executed by a processor, is configured to control a method for tracking and reporting continuing education credit for a plurality of continuing education conference attendees, the method comprising:
assigning a unique identification number to each of a plurality of conference attendees and a unique workshop identification number to each of a plurality of workshops offered at a continuing education conference;
reading the unique identification number for each attendee at a particular workshop and associating the unique workshop identification number with each workshop attendee's unique identification number in a conference database; and
generating continuing education certificate representing each workshop attended by each conference attendee.

11. The computer program of claim 10, wherein the method further comprises populating a database with the unique identification number and the unique workshop identification number during an attendee registration process.

12. The computer program of claim 11, wherein reading the unique identification number for each attendee at a particular workshop comprises optically scanning or sensing via radio frequency, the attendee's unique identification number.

13. The computer program of claim 12, wherein generating continuing education certificate comprises at least one of locally printing a continuing education certificate for the attendee or automatically transmitting a continuing education certificate to a governing body.

14. The computer program of claim 13, wherein the computer program is contained in a plurality of kiosks positioned proximate the conference, where each of the plurality of kiosks are in communication with a database containing associated unique attendee identification numbers and unique workshop identification numbers.

15. A system for tracking and reporting continuing education credits for a plurality of continuing education conference attendees, the system comprising:
a plurality of kiosks in communication with each other;
an input module and an output module;
a processor in communication with the input module and the output module;
a memory configured to contain a computer program for controlling the tracking and reporting process; and
at least on database in communication with the processor, the database containing a unique attendee identification number for each conference attendee and a unique workshop identification number for each workshop offered at the conference,
wherein the plurality of kiosks are configured to receive inputs representative of conference attendees attending specific workshops and to generate a corresponding continuing education certificate representative thereof.

16. The system of claim 15, further comprising a transmission module configured to transmit information between the plurality of kiosks.

17. The system of claim 16, wherein the at least on database is positioned in one of the plurality of kiosks or in a remotely located control station.

18. The system of claim 15, wherein the transmission module is configured to automatically electronically transmit the continuing education certificate to a governing body.

19. The system of claim 15, further comprising a means for determining conference attendees attending specific workshops.

20. The system of claim 15, wherein each of the plurality of kiosks are configured to receive inputs representative of conference attendees attending a specific workshop and to generate a corresponding continuing education certificate.
